(19) United States
(12) Patent Application Publication
(10) Pub. No.: US 2005/0049330 A1
(43) Pub. Date: Mar. 3, 2005

(54) Microfine relatively high molecular weight polyethylene powders

(76) Inventor: Douglas C. McFaddin, Cincinnati, OH (US)

Correspondence Address: EQUISTAR CHEMICALS, L.P., 11530 NORTHLAKE, CINCINNATI, OH, 45249, US

(21) Appl. No.: 10/649,988

(22) Filed: Aug. 27, 2003

(51) Int. Cl. C08K 7/16

(52) U.S. Cl. 523/223

(57) ABSTRACT

Microfine low density polyethylene powders are provided. The powders are comprised of spherical or substantially spherical particles having an average particle size of 5 microns or less produced by a dispersion process. The powders, by virtue of their relatively high molecular weights compared to conventional polyethylene waxes, have a useful balance of physical properties.

### BACKGROUND OF THE INVENTION

1. Field of the Invention

The invention relates to microfine high molecular weight polyethylene powders. The small particle size, substantially spherical, high molecular weight powders have a balance of properties making them suitable for use in inks and coatings and for other applications.

2. Description of the Prior Art

Numerous types of waxes, including polyethylene waxes, have been used in various ink and coating systems to improve surface slip and reduce damage due to scuffing and rubbing. Major wax types include polyethylene waxes, paraffin waxes, microcrystalline waxes, Fischer-Tropsch waxes, camauba wax and polytetrafluoroethylene waxes. Comparative properties of these major wax types are set forth in the article by J. R. Carroll, et al., Surf. Coat. Int., 1994, Vol. 77, No. 10, pp. 435-441. With the exception of the tetrafluoroethylene polymer waxes, all of the waxes are low molecular weight products. The maximum molecular weights reported for even the polyethylene waxes is 12000.

There are several theories on how waxes actually work in a dried ink film or coating. The two most generally accepted theories are the “flotation” and “pedestal” theories. In flotation it is thought that a significant percentage of wax particles rise to the surface of the film due to surface tension or the insolubility relationship between the wax and the ink/coating. Once at the surface the wax particles will provide protection for the ink or coating.

The pedestal theory postulates that wax particles which are larger in diameter than the dried ink film protrude above the surface of the film and these discrete dispersed protruding particles provide a protective barrier that improves surface slip and reduces damage to the film due to scuffing and rubbing.

While authorities may disagree as to the exact mechanism by which waxes function, there is general agreement that in order to obtain the optimal balance of properties, the wax particle size and particle size distribution play a major role. While large wax particles in an ink can improve slip and scuff, they can also cause problems during the printing process and lead to reduction in the gloss of the ink film. On the Schuman-Sasol website it is stated: “Optimum wax performance in a printing ink generally takes place when the wax particles are of similar diameter as the printed ink film. Ink films vary between 1-2 microns for some offset inks produced at high speeds and can be up to 18 microns for some liquid inks. For use in most pigmented printing inks, the optimum wax particle size is between 5 and 20 microns.” Using waxes having particle sizes substantially greater than the ink film thickness lowers gloss due to the effect the larger particles have on the reflective properties of the film. As a result, a balance needs to be struck between scuff and rub properties and gloss.

In view of the generally accepted relationship between film thickness and wax particle size it would be desirable to have small particle size powders available when formulating offset printing inks where the resulting ink films are typically less than 5 microns thick. It would be even more advantageous if the powder particles were spherical or substantially spherical in shape so as to provide excellent slip and light reflection characteristics relative to irregularly shaped particulate products, such as obtained by grinding procedures, and if the powders were polyethylene powders having substantially higher molecular weights and correspondingly improved physical properties compared to lower molecular weight polyethylene waxes typically employed for inks and coatings. The above-stated and other objects are achieved with the powders of the present invention which will be described in more detail to follow.

### SUMMARY OF THE INVENTION

The present invention relates to low density polyethylene powders wherein the particles are spherical or substantially spherical in shape and the average particle size is 5 microns or less. The powders, which are produced by a dispersion process, are further characterized by having a relatively narrow particle size distribution.

More specifically, the improved powders of the invention are microfine polyethylene powder comprised of particles which are spherical or substantially spherical in shape and having an average particle size from 1 to 5 microns and wherein 80 percent or more of the particles range in size from 0.1 to 7 microns, said polyethylene powder having a weight average molecular weight from 20000 to 55000 g/mol and density from 0.895 to 0.925 g/cm³. In a particularly useful embodiment the polyethylene powders are ethylene homopolymer polymers having Brookfield viscosities (at 149° C.) in the range 4000 to 10000 centipoise.

The microfine low density polyethylene powders are produced by a dispersion process wherein the polyethylene resin having a weight average molecular weight from 20000 to 55000 g/mol and density from 0.895 to 0.925 g/cm³ is combined with a nonionic surfactant, preferably a block copolymer of propylene oxide and ethylene oxide, in a polar liquid medium containing at least 50 weight percent water. The mixture is then heated above the melting point of the polyethylene resin and agitated to disperse the polyethylene resin in the polar liquid. The dispersion is then cooled to below the melting point of the polyethylene resin and the microfine polymer powder recovered.

Highly useful powders produced using the above-described aqueous dispersion techniques are obtained using ethylene homopolymers having densities from 0.899 to 0.920 g/cm³ and weight average molecular weights from 30000 to 50000 g/mol. It is even more preferred when the powders have an average particle size of 2 to 4 microns with 80 percent or more of the particles ranging in size from 0.5 to 5 microns.

### DETAILED DESCRIPTION

The polyethylene (PE) powders of the invention, generally referred to herein as microfine powders and, more specifically as high molecular weight microfine powders, are characterized by having particles which are spherical or substantially spherical in shape with an average or median particle size of about 5 microns or less. The term high molecular weight as used herein is employed not in an absolute sense but rather relative to heretofore available PE waxes.

The powders, produced by dispersion processes from low density PE resins having specified molecular weights, are useful for inks and coatings. The microfine powders are also useful as binders for carbon and other particulate materials used to manufacture blocks and other molded shapes.

The particle size distribution of the microfine powders of the invention is relatively narrow compared to powders typically produced by mechanical means, i.e., grinding. While ground powders can be sieved to isolate particles within specific size ranges, this requires additional handling and equipment. Moreover, powders produced by grinding processes have highly irregular shapes which can adversely affect the surface properties of coatings and inks formulated therewith.

The microfine high molecular weight PE powders of the invention are produced using a dispersion process. To obtain the powders, a PE resin having the requisite properties is charged to the reactor with a polar liquid medium and a nonionic surfactant and a dispersion is formed in accordance with conventional dispersing procedures known to the art. The PE resin when introduced to the dispersing apparatus may be a reactor-produced powder having substantially larger particle size or may be in pellet form.

The dispersing apparatus may be any device capable of delivering sufficient shearing action to the mixture at elevated temperature and pressure. Conventional propeller stirrers designed to impart high shear commercially available for this purpose can be used. The reactor may also be equipped with baffles to assist in dispersion. The particle size and distribution of particles is dependent on the shearing action which, in turn, is related to the stirrer design and rate of stirring. Agitation rates can vary over wide limits but the speed of the stirrer will usually be controlled so that the tip speed is between about 500 and 3500 ft/min and, more commonly, 750 and 3000 ft/min. A higher tip speed is generally required for batch operation, usually 2500-3000 ft/min. Tip speeds for continuous procedures will most generally be between 750 and 2500 ft/min.

The dispersion process is typically conducted in an autoclave since this permits the process to be conducted at elevated temperature and pressure. In batch procedures, all of the ingredients are charged to the autoclave and the mixture is heated to a temperature above the melting point of the PE. While the temperature will vary depending on the specific PE used, it will typically range from about 90° C. to 250° C. Since the fluidity of PE polymers is temperature related, it may be desirable to carry out the process at temperatures substantially above the melting point of the PE to facilitate dispersion formation. Stirring is commenced after the desired temperature is reached. Dispersions of the desired droplet size are usually rapidly achieved. Most generally, stirring is maintained for a period from 5 to 15 minutes.

A polar liquid medium which is not a solvent for the PE and which does not react under the process conditions is employed to form the dispersions. These polar mediums are hydroxylic compounds and can include water, alcohols, polyols and mixtures thereof. The weight ratio of the polar liquid medium to PE ranges from about 0.8:1 to about 9:1 and, more preferably, from 1:1 to 5:1. It is particularly advantageous to use water as the dispersing medium or to use a liquid medium where water is the major component. The pressure of the process is not critical so long as a liquid phase is maintained and can range from about 1 up to about 217 atmospheres. The process can be conducted at autogenous pressure or the pressure can be adjusted to exceed the vapor pressure of the liquid medium at the operating temperature. Most generally, with aqueous dispersions the pressure will range from about 5 to 70 atmospheres.

To obtain suitable PE dispersions, one or more dispersing agents are employed for the process. Useful dispersing agents are nonionic surfactants which are block copolymers of ethylene oxide and propylene oxide. Preferably, these nonionic surfactants are water-soluble block copolymers of ethylene oxide and propylene oxide and have molecular weights greater than about 3500. Most will contain a major portion by weight of ethylene oxide and are obtained by polymerizing ethylene oxide onto preformed polyoxypropylene segments. The amount of nonionic surfactant employed can range from about 4 to 50 percent, based on the weight of the PE. Most preferably, the nonionic surfactant is present from about 7 to 45 percent, based on the weight of the PE polymer.

Useful nonionic surface active agents of the above type are manufactured and sold by BASF Corporation, Chemicals Division under the trademark PLURONIC. These products are obtained by polymerizing ethylene oxide on the ends of a preformed base polymer of polyoxypropylene. Both the molecular weight of the polyoxypropylene base polymer and the polyoxyethylene segments can be varied to yield a wide variety of products. One such compound found to be suitable to produce the powders of this invention is the product designated as F-98 wherein a polyoxypropylene of average molecular weight of 2,700 is polymerized with ethylene oxide to give a product of molecular weight averaging about 13,500. This product contains 20 weight percent propylene oxide and 80 weight percent ethylene oxide. Other effective Pluronic® include F-88 (M. W. 11,250, 20% propylene oxide, 80% ethylene oxide), F-108 (M. W. 16,250, 20% propylene oxide, 80% ethylene oxide), and P-85 (M. W. 4,500, 50% propylene oxide, 50% ethylene oxide). These compounds, all containing at least about 50 weight percent ethylene oxide and having molecular weights of at least 4,500, are highly effective as dispersing agents for the aforementioned olefin copolymers.

It is also possible to employ surfactants sold under the trademark TETRONIC which are prepared by building propylene oxide block copolymer chains onto an ethylenediamine nucleus and then polymerizing with ethylene oxide. Tetronic® 707 and Tetronic® 908 are representative of these types of surfactants. Tetronic® 707 has a 30 weight percent polyoxypropylene block of 2,700 molecular weight, polymerized with a 70 weight percent oxyethylene portion to give an overall molecular weight of 12,000. Tetronic® 908, on the other hand, has a 20 weight percent polyoxypropylene block of 2,900 molecular weight, polymerized with an 80 weight percent oxyethylene portion to give an overall molecular weight of 27,000. In general, useful Tetronic® surfactants have molecular weights above 10,000 and contain a major portion by weight of ethylene oxide.

The process may also be conducted in a continuous manner or in a re-circulating autoclave batch process. If continuous operation is desired, the essential ingredients are continuously introduced to the system while removing from another part of the system the dispersion of the PE polymer. The ingredients may be separately charged or two or more may be combined for introduction. In a re-circulating system it may be advantageous to provide both bulk mixing as well as high intensity mixing by passing the slurry through a closed loop in-line high shear mixer. The number of passes, the tip speed and design of the mixing head can be used to adjust the particle size distribution in the final dispersion.

To produce PE powders having the desired particle size distribution, a dispersion having droplets of the desired size must be formed. This requires a proper selection of the operating conditions, such as, temperature and agitation, as well as proper selection of the dispersing agent (surfactant) to coat the droplets. After dispersion with particles of the desired particle size is achieved, the temperature of the dispersion is lowered to below melting temperature of the PE polymer and the PE powder is separated from the liquid phase by filtration, centrifugation, decantation, evaporation, or the like. In a highly useful embodiment of the invention, the temperature of the dispersion is lowered to below the boiling point of the water or other liquid medium and the finely divided PE polymer is recovered by filtration. The cooling may be accomplished by removing the heating source and allowing the mixture to cool or the hot dispersion may be rapidly quenched by mixing with cold liquid which is not a solvent for the polymer. This liquid may be the same or different than that employed as the dispersing medium. Water is preferably used for this purpose. The recovered PE polymer powder is typically washed with water to remove residual surfactant before drying.

The particle size is sufficiently small to make traditional cake filtration slow. Although it is possible to spray dry samples into droplets to form re-dispersible powders this is often not desirable due to the presence of surfactants which can interfere in the final properties of the coating. It is advantageous in most cases to remove dissolved solids such as surfactants by washing and filtering the samples. It is possible to employ traditional diafiltration methods using a membrane filter capable of providing shear at the filter surface. With the proper selection of membrane and operating conditions systems such as a Cross-Rotational Membrane Filter (CR200/1—supplied by Komline Sanderson) or a Vibrating Membrane Filter (VSEP®—supplied by New Logic Research Inc.) are capable of removing dissolved solids from a sample containing high levels of suspended solids. Once the desired level of dissolved solids is achieved the slurry can be concentrated to total solids contents of 30-40 wt. %.

The concentrated slurry can be dried using a number of methods, which could include oven drying or spray drying. On a small scale the slurry can be easily dried in an oven to remove the moisture. Stirring paddles or sample movement improves the rate of moisture removal. In all cases the temperature needs to be kept below the melting point of the sample in order to prevent melting and permanent fusing of the particles.

PE resins utilized in the above-described dispersion process to obtain the microfine powders of the invention are low density polyethylenes (LDPEs) produced by conventional high pressure polymerization processes known to the art. Densities of the LDPEs range from 0.895 to 0.925 g/cm³ and, more preferably, from 0.899 to 0.920 g/cm³. The LDPE microfine powders produced in accordance with the invention have high molecular weights relative to PE wax powders currently used for coatings and inks. LDPE resins used to produce the improved microfine powders of the invention have weight average molecular weights (M_{w}) from 20000 to 55000 g/mol and, more preferably, 30000 to 50000 g/mol. By comparison, a widely used commercial PE wax (Baker Petrolite Polywax® 3000) from which various ground powders are produced has a M_{w} of only 3000 g/mol determined using the same measurement conditions.

Even though the microfine powders produced have molecular weights substantially higher than conventional PE wax powders heretofore used, the melt flow rates of these microfine PE powders are still too high to be characterized by traditional melt index (MI) measurements used for conventional PE resins. ASTM D1238-99, the procedure used to determine MI, indicates that MI measurements are difficult to obtain accurately when the MI values are greater than 900 g/10 min. As a result, the PE resins used and microfine powders of the invention produced therefrom are characterized by measuring their viscosity using Brookfield viscometry at 149° C. in accordance with ASTM D 3236. Viscosities of the LDPEs used and the resulting microfine powders range from 4000 to 10000 centipoise (cP) and, more preferably, from 6000 to 9000 cP. This is compared to viscosity of only 130 cP for the above-referenced 3000 M_{w} commercial PE wax powders.

In addition to having the above-specified densities and molecular weights, microfine powders obtained by the dispersion process in accordance with the invention are further characterized by having particles which are spherical or substantially spherical in shape and the average (median) particle size is 5 or less and at least 80 percent or more of the particles range in size from 0.1 to 7 microns, i.e., no more than 10 percent of the particles are smaller than 0.1 microns and no more than 10% of the particles are larger than 7 microns. More preferably, the average particle size is from 1 to 5 microns and powders wherein the average particle size is from 2 to 4 microns and 80 percent or more of the particles range in size from 0.5 to 5 microns are particularly advantageous.

The following examples illustrate the process of the invention and the improved powders obtained therefrom more fully. As will be apparent to those skilled in the art, numerous variations of the described procedures are possible and are within the scope of the invention.

The PE powders produced in these examples were analyzed using laser light scattering to determine average particle size and particle size distribution. A Model 2600C Malvern Particle Size Analyzer with a lens configuration for the expected particle size to be measured and equipped to automatically calculate the distribution curve and average particle size was used. For the analysis, water was charged to the water bath and circulated through the sample measuring chamber. After obtaining the baseline measurement, the agitator and sonic vibrator were turned on and the powder added to the water bath until the obscuration reading is 0.3. Mixing and circulation were controlled to obtain acceptable dispersion without excessive foaming. A drop of liquid detergent was added to facilitate dispersion. After eight minutes agitation, measurements were taken over a period of time and the distribution curve and average particle size calculated. Duplicate runs are made for each powder sample. The particle size reported in the examples is the median volume particle size D(v, 0.5). The range reported for the particle size distribution in the examples is for 80 percent of the distribution curve. Ten percent of the powder particles will fall below the lower limit of the recited distribution and 10 percent of the PE powder particles will be larger than the upper recited particle size distribution limit.

For the examples, an electrically heated two-liter Paar pressure reactor equipped with thermowell and thermocouple connected to a digital display was used. The reactor was also equipped with an agitator and a Strahman valve to permit rapid discharge of the hot dispersion. The agitator had three, six-bladed, impellers and was driven by a 2 HP DC variable speed motor.

### Example 1

A 2 L autoclave was charged with 454 g of LDPE pellets, along with 120 g. of F98 Pluronic Surfactant and 850 g of deionized water. The LDPE had a density of 0.903 g/cm³, M_{w} of 40000 g/mol, melting point of 95° C. and Brookfield viscosity @ 149° C. of 8800 cP. The reactor was heated to 180° C. and agitated with a tip speed of 1200 ft/min for 5 minutes. The slurry was cooled to room temperature and diluted with several liters of deionized water. The sample was filtered using CR-200/1 membrane filter from Komline Sanderson. The membrane was made from PVDF and had a molecular weight cut off of 250,000 amu. The constant volume diafiltration proceeded until the residual surfactant accounted for less than 1.5 wt % of the dried solids. The sample was concentrated to 35 wt % solids and then dried in an air circulating oven at 80° C. The sample was dried and gently pulverized to remove any agglomerates. The microfine LDPE powder had a median particle size of 2.6 microns and particle size distribution such that 80% of the particles were sized between 2.0 and 4.4 microns.

### Example 2

Example 1 was repeated except that the dispersion process conditions were varied. The reactor was heated to 200° C. and agitated with a tip speed of 1200 ft/min for 5 minutes. The resulting microfine powder had a median particle size of 1.9 microns and a particle size distribution such that 80% of the particles were sized between 0.8 and 3.8 microns.

### Example 3

The conditions of Example 1 were repeated using 52 g of F98 and a LDPE resin having a density of 0.906 g/cm³, melting point of 97° C., M_{w} of 36000 g/mol and Brookfield viscosity @ 149° C. of 7800 cP. The reactor was heated to 165° C. and agitated with a tip speed of 1200 ft/min for 5 minutes. The resulting microfine powder had a median particle size of 1.2 microns and particle size distribution such that 80% of the sample mass existed as particles between 0.7 and 2.1 microns in diameter.

### Example 4

The dispersion conditions employed in Example 1 were repeated using a polyethylene sample having a density of 0.918 g/cm³, melting point of 107° C., and Brookfield viscosity at 149° C. of 8800 cP. The microfine powder produced had a median particle size of 3.2 microns and particle size distribution such that 80% of the particles were sized between 2.6 and 4.2 microns.

### Example 5

To demonstrate the utility of the microfine LDPE powders of the invention for coatings, flat, semi-gloss and high gloss paint systems were formulated using the powder of Example 1. A powder dispersion was used to prepare the various paint formulations. The powder dispersion contained 54.2 wt. % water, 0.3 wt. % defoamer (SERDAS 7005), 2 wt. % surfactant (TRITON X405), 3 wt. % butyl CARBITOL, 0.5 wt. % urethane thickener and 40 wt. % of the microfine LDPE powder. To prepare the dispersion the defoamer was combined with the water (warm) in a laboratory scale dispersion apparatus and mixed at low speed for 5 minutes. The surfactant and butyl CARBITOL were then separately added, each followed by 5 minutes low speed mixing. The microfine powder was then added and mixed at high speed for 20 minutes. Finally, the urethane thickener was added to the dispersion and mixed for an additional 5 minutes. The dispersion was then incorporated into standard flat, semi-gloss and high gloss paint formulations.

The paint formulations were evaluated for ease of application, film appearance and clarity, adhesion, resistance to burnishing, scuffing and scrubbing, blocking resistance and slip resistance in accordance with standard industry procedures wherein each of the formulations was rated on a scale of 10 (excellent) to 1 (poor). For example, for film appearance a rating of 10 indicates a smooth film, 5 indicates a film which is slightly grainy and 1 indicates the film is very grainy. The films were also rated for general durability utilizing the same rating system. Results obtained for the paint films prepared using dispersions of the microfine powders of the invention were as follows:

| | Flat Paint | Semi-Gloss Paint | High Gloss Paint |
|---|---|---|---|
| Application | 8 | 8 | 8 |
| Film Appearance | 10 | 10 | 9 |
| Film Clarity | 9 | 10 | 9 |
| Adhesion | 8 | 9 | 10 |
| Burnish Resistance | 8 | 8 | 9 |
| Scuff Resistance | 7 | 9 | 10 |
| Scrub Resistance | 10 | 10 | 10 |
| Blocking Resistance | 10 | 10 | 10 |
| Slip Resistance | 7 | 6 | 5 |
| General Durability | 10 | 10 | 10 |

The above results demonstrate that paint formulations produced using the microfine LDPE powders of the invention provide coatings having good appearance with superior scrub and blocking resistance.

### Example 6

The suitability of the microfine LDPE powders of the invention to be used as binders for particulate materials is apparent from the following example. For this procedure 20 grams granular activated carbon are mixed with 5 grams of the microfine powder. A cylindrical two piece mold open at one end is filled with the mixture and the mold and its contents heated to 120° C. and maintained for 5 minutes while applying a pressure of 20 psi to the top of the mixture within the mold. The mold and its contents are then allowed to cool to ambient temperature while maintaining the pressure. When the mold is removed, a bonded activated carbon cylindrical block structure having good physical integrity, i.e., not easily friable, is obtained. Structures of this type are useful as water filter cartridges.

1. A microfine polyethylene powder comprised of particles which are spherical or substantially spherical in shape and having an average particle size from 1 to 5 microns and wherein 80 percent or more of the particles range in size from 0.1 to 7 microns, said polyethylene powder having a weight average molecular weight from 20000 to 55000 g/mol and density from 0.895 to 0.925 g/cm³.

2. The microfine powder of claim 1 wherein the polyethylene is an ethylene homopolymer having a Brookfield viscosity in the range 4000 to 10000 centipoise.

3. The microfine powder of claim 2 wherein the ethylene homopolymer has a weight average molecular weight from 30000 to 50000 g/mol.

4. The microfine powder of claim 3 wherein the ethylene homopolymer has a density from 0.899 to 0.920 g/cm³.

5. The microfine powder of claim 3 wherein the ethylene homopolymer has a Brookfield viscosity in the range 6000 to 9000 centipoise.

6. The microfine powder of claim 1 having an average particle size of 2 to 4 microns.

7. The microfine powder of claim 6 wherein 80 percent or more of the particles range in size from 0.5 to 5 microns.

8. The microfine powder of claim 1 produced in an aqueous dispersion process.

9. The microfine powder of claim 8 produced by
(a) combining a polyethylene resin having a weight average molecular weight from 20000 to 55000 g/mol and density from 0.895 to 0.925 g/cm³ with a nonionic surfactant and polar liquid medium containing at least 50 weight percent water;
(b) heating the mixture above the melting point of the polyethylene resin;
(c) agitating the mixture to disperse the polyethylene in the polar liquid medium;
(d) cooling the dispersion below the melting point of the polyethylene resin; and
(e) recovering the microfine powder.

10. The microfine powder of claim 9 produced by the process wherein the weight ratio of polar liquid medium to polyethylene resin is from 0.8:1 to 9:1 and the nonionic surfactant is employed in an amount from 4 to 50 weight percent, based on the weight of the polyethylene resin.

11. The microfine powder of claim 10 produced by the process wherein the mixture is heated to 90° C. to 250° C., the agitator tip speed is from 500 to 3500 ft/min and the nonionic surfactant is a block copolymer of ethylene oxide and propylene oxide having a molecular weight greater than 3500.

12. The microfine powder of claim 11 produced by the process wherein the dispersion from (d) is washed and concentrated by high shear membrane filtration prior to recovery of the microfine powder.
